(19) United States
(12) Patent Application Publication
(10) Pub. No.: US 2026/0213057 A1
(43) Pub. Date: Jul. 23, 2026

(54) YOKE MEMBER AND SCANNER DEVICE

(71) Applicant: TOPCON CORPORATION, Itabashi-Ku, Tokyo (JP)

(72) Inventors: Shingo IWASAKI, Itabashi-Ku (JP); Eiji KUROKI, Itabashi-Ku (JP)

(21) Appl. No.: 19/138,912

(22) PCT Filed: Dec. 14, 2023
(86) PCT No.: PCT/JP2023/044900

§ 371 Date: Jun. 13, 2025

(30) Foreign Application Priority Data
Dec. 14, 2022 (JP) 2022-199199

(51) Int. Cl. H01F 7/08; G01S 7/08; G01S 7/481; H01F 27/24; H01F 27/28

(52) U.S. Cl. CPC H01F 7/081; G01S 7/08; G01S 7/4817; H01F 27/24; H01F 27/28

(57) ABSTRACT

The yoke member includes first yokes having a pair of first end portions facing each other, and second yokes having a pair of second end portions facing each other in a direction different from the facing direction of the first end portions. Further, the first yokes and the second yokes are connected such that portions of magnetic circuits intersect, thereby equalizing magnetic path lengths.

### TECHNICAL FIELD

The present disclosure relates to a yoke member and a scanner device.

### BACKGROUND ART

Traditionally, technology related to controlling of the angle of a mirror using two pairs of yoke coils has been proposed. For example, Patent Document 1 discloses a scanner device (mirror scanner) including a first yoke having a pair of cores and a second yoke having a pair of cores. In this scanner device, the first yoke is arranged such that one end of each of the cores in pair faces a surface on the side opposite to the reflection surface of the mirror, and the second yoke is arranged such that one end of each of the cores in pair faces the surface on the side opposite to the reflection surface. A straight line connecting the one ends of the second yokes intersects a straight line connecting the one ends of the first yokes.

### CITATION LIST

### Patent Document

Patent Document 1: Japanese Unexamined Patent Publication No. 2021-33087

### SUMMARY OF THE INVENTION

### Technical Problems

In the scanner device of Patent Document 1, the first yokes and the second yokes are configured as separate components. Therefore, in such a scanner device, the first yokes and the second yokes need to be arranged so as not to interfere with each other, which imposes constraints on the layout and may result in an increase in the overall size of the scanner device.

An object of the present disclosure is to provide compact yoke members and a compact scanner device.

### Solution to the Problems

A yoke member of the present disclosure includes: first yokes having a pair of first end portions facing each other; and second yokes having a pair of second end portions facing each other in a direction different from a facing direction of the first end portions, wherein the first yokes and the second yokes are connected such that portions of magnetic circuits intersect, thereby equalizing magnetic path lengths.

A scanner device of the present disclosure includes: an electromagnet having the yoke member, and yoke coils provided on the first arm members of the first yokes and the second arm members of the second yokes; and a deflection member that is arranged between the first end portions in pair and between the second end portions in pair and is angle-controlled by the electromagnet.

### Advantageous of the Invention

The yoke member and the scanner device according to the present disclosure with the above-described means can be made compact.

### BRIEF DESCRIPTION OF THE DRAWINGS

FIG. 1 is a configuration diagram of a light source device of an embodiment of the present disclosure.

FIG. 2 is a perspective view of a part of the scanner device.

FIG. 3 is an exploded perspective view of a part of the scanner device.

FIG. 4 is a cross-sectional view of a part of the scanner device, taken along line IV-IV.

FIG. 5 is a cross-sectional view of a yoke member, taken along line V-V.

FIG. 6 is an enlarged cross-sectional view, taken along line IV-IV of FIG. 4.

FIG. 7 is a schematic top view of a detection unit.

FIG. 8 is a diagram showing an irradiation region of laser light that is emitted toward a light receiving unit via a light selection unit of second and third embodiments.

FIG. 9 is a schematic view showing changes in the intensity distribution of laser light in an optical path from the light source to the detection unit, as viewed from two orthogonal directions.

FIG. 10 is a diagram showing an irradiation region of laser light that is emitted toward a light receiving unit via a light selection unit of fourth and fifth embodiments.

FIG. 11 is an enlarged view at a position corresponding to a cross-section taken along line IV-IV of a scanner device including a deflection member according to a sixth embodiment.

FIG. 12 is a perspective view of a yoke member of a seventh embodiment.

FIG. 13 is a cross-sectional view of the yoke member taken along line XIII-XIII in FIG. 12.

FIG. 14 is a cross-sectional view of a yoke member of an eighth embodiment, showing a position corresponding to a cross-section taken along line XIII-XIII.

FIG. 15 is a perspective view of a yoke member of a ninth embodiment.

FIG. 16 is a cross-sectional view of the yoke member taken along line XVI-XVI in FIG. 15.

FIG. 17 is a perspective view of a yoke member of a tenth embodiment.

### DESCRIPTION OF EMBODIMENTS

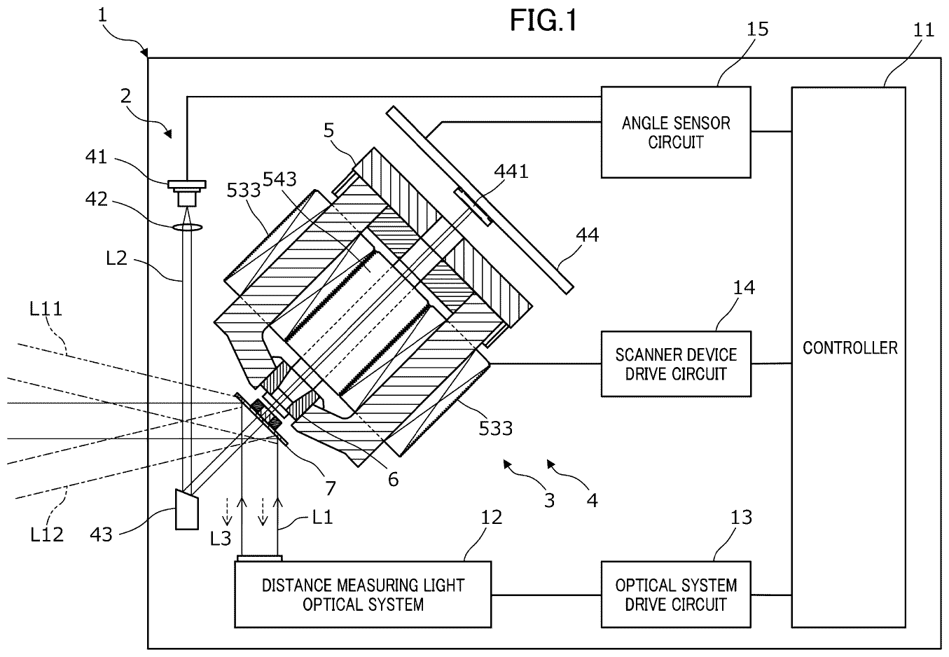

Embodiments of the present disclosure will be described below with reference to the drawings. FIG. 1 is a configuration diagram of a light source device 1. The light source device 1 has a function of emitting laser light into space. The light source device 1 is used, for example, as a light source of a laser distance measuring device or a light detection and ranging (LIDAR) sensor. The light source device 1 includes a controller 11, a distance measuring light optical system 12, an optical system drive circuit 13, and a scanner device 2.

The controller 11 controls operations of the optical system drive circuit 13, a scanner device drive circuit 14, an angle sensor circuit 15, and the like. The controller 11 executes the functions and/or methods implemented by codes or commands included in the programs stored in the storage (not shown). The controller 11 may include a central processing unit (CPU), a micro-processing unit (MPU), GPU, a microcontroller unit (MCU), a processor core, a multiprocessor, ASIC, FPGA, and the like. The controller 11 may include a logic circuit or a dedicated circuit formed in an integrated circuit, for example, to execute the processing disclosed in the embodiments. These circuits may be one or more integrated circuits. A single integrated circuit may execute the plural types of processing described in the embodiment.

The storage (not shown) of the light source device 1 has the function of storing various programs or various data sets that are needed. The storage can store acquired information, such as signals measured. The storage is implemented as various storage media, such as a hard disk drive (HDD), a solid state drive (SSD), and a flash memory.

The distance measuring light optical system 12 includes a light emitting element configured to emit laser light, an optical element including a lens, a mirror, or the like, which is configured to guide laser light emitted by the laser emitting element, and a light receiving element configured to detect laser light. The optical element may include a diffusion plate, a light tunnel, a microlens array, a condenser lens, a filter, or the like to adjust the beam width or brightness distribution, The light receiving element can receive light emitted from the laser emitting element, which has been reflected by an object outside the light source device 1. The distance measuring light optical system 12 emits, to a deflection member 7 of the scanner device 2, laser light L1 that is distance measuring light (first light).

The optical system drive circuit 13 controls light emission of the light emitting element of the distance measuring light optical system 12. Further, the optical system drive circuit 13 detects light received by the light receiving element of the distance measuring light optical system 12, converts the light into electric information, and transfers the electric information to the controller 11.

The scanner device 2 reflects the laser light L1 emitted from the distance measuring light optical system 12 in a direction and at an angle selected from a predetermined range of solid angles, and emits the laser light L1 as output light to the outside of the light source device 1. The scanner device 2 controls the angle of the deflection member 7 to reflect the laser light L1 in different directions, as exemplified by laser light L11 or laser light L12, Further, the scanner device 2 guides light having entered from outside the light source device 1 to the distance measuring light optical system 12. Light entering from outside the light source device 1 is reflected light L3 reflected by an object outside the light source device 1. Note that, depending on the configuration of the light source device 1, the laser light L1 emitted from the light source device 1 may be guided to another optical system inside the light source device 1.

The scanner device 2 includes a mirror control device 3, an inclination detection device 4, and a support member 6. The mirror control device 3 of the present embodiment includes a yoke member 5, the deflection member 7, and the scanner device drive circuit 14. The inclination detection device 4 of the present embodiment includes a light source 41 configured to emit laser light L2 serving as inclination detection light (second light), a lens 42, a deflection member 43 (second deflection member), a detection circuit board 44, and the angle sensor circuit 15. The deflection member 7 also functions as a part of the inclination detection device 4.

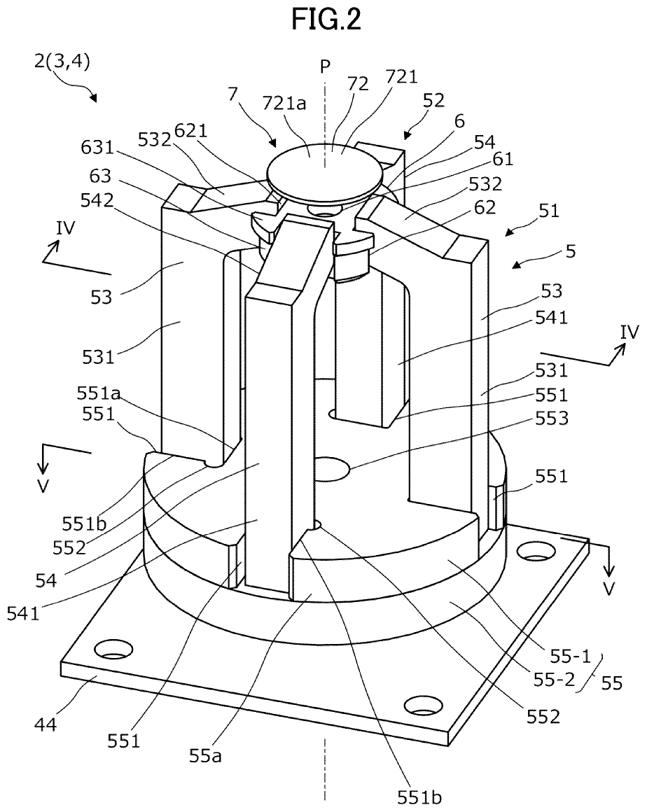

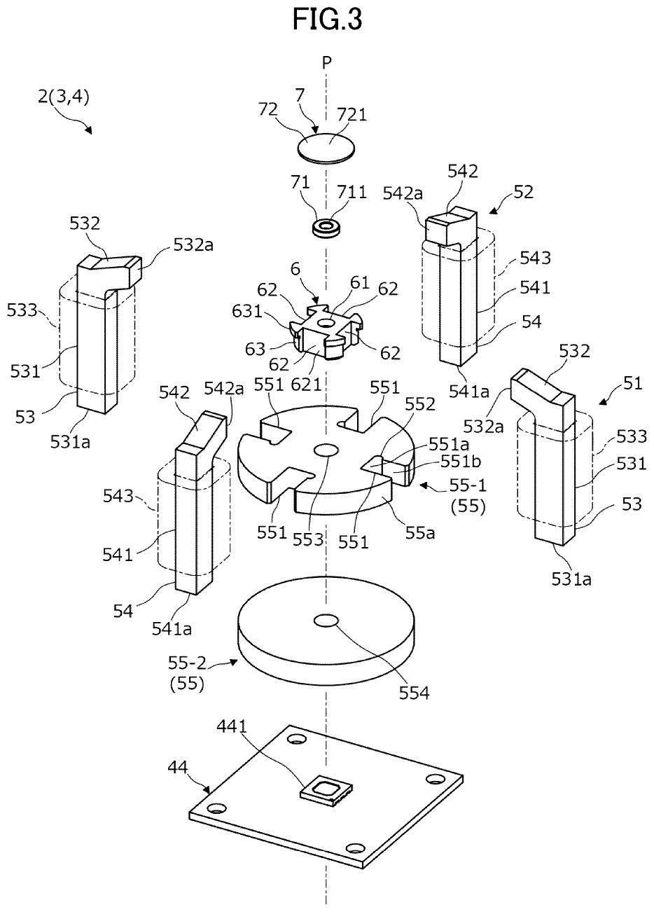

FIG. 2 is a perspective view of a part of the mirror control device 3 and a part of the inclination detection device 4 of the scanner device 2. Note that the deflection member 7 side is regarded as the upper side of the scanner device 2, whereas the base member 55 side is regarded as the lower side, in the description of the scanner device 2. FIG. 3 is an exploded perspective view of a part of the mirror control device 3 and a part of the inclination detection device 4 of the scanner device 2.

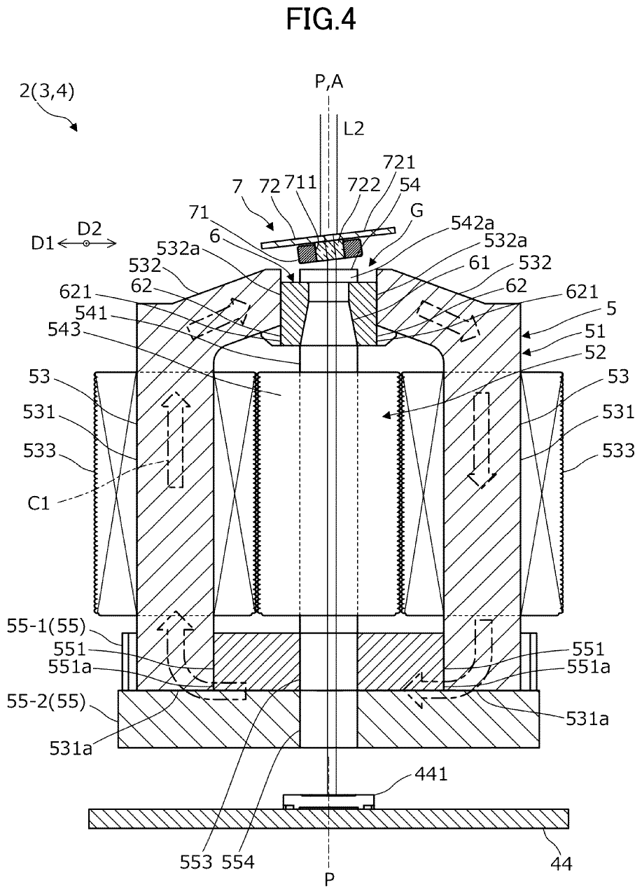

The yoke member 5 includes a pair of first yokes 51 and a pair of second yokes 52 different from the first yokes 51 and arranged in a rotationally symmetrical position about an axis P of the scanner device 2. The pair of first yokes 51 include a pair of first arm members 53, 53 having first end portions 532a, 532a, and the base member 55 connected to portions opposite to the first end portions 532a, 532a of the first arm members 53, 53. Further, the pair of second yokes 52 include a pair of second arm members 54, 54 having second end portions 542a, 542a, and the base member 55 connected to portions opposite to the second end portions 542a, 542a of the second arm members 54, 54 (see FIGS. 2 and 4).

The first yokes 51 and the second yokes 52 have magnetic properties. The first arm member 53 and the second arm member 54 have substantially quadrangular prism-shaped body parts 531, 541 having a rectangular cross-section, and protrusions 532, 542 extending on one side of the body parts 531, 541 and bent into a substantially L shape, respectively. The protrusions 532, 542 have, at their respective leading ends, a flat first end portion 532a and a flat second end portion 542a.

The body part 531 of each of the first arm members 53 has a yoke coil 533 wound about its outer circumference. The yoke coils 533 of the first arm members 53 in pair are serially connected to each other. Further, a body part 541 of each of the second arm members 54 has a yoke coil 543 wound about its outer circumference. The yoke coils 543 of the second arm members 54 in pair are also serially connected to each other. Thus, the yoke member 5 and the yoke coils 533, 543 form an electromagnet. The scanner device drive circuit 14 drives the electromagnet to control the angle of the deflection member 7 based on an instruction from the controller 11.

The base member 55 has a magnetic property. The base member 55 has a first base member 55-1 and a second base member 55-2, both having a disc shape. The first base member 55-1 has cut-out portions 551 on two sets of opposing side edges 55a. The outer diameters of the first base member 55-1 and the second base member 55-2 are substantially the same (see FIGS. 2 and 4). The first base member 55-1 has the cut-out portions 551 with a substantially rectangular shape in top view. Further, the cut-out portion 551 has a groove-like relief portion 552 at a boundary portion between an inner surface 551a on the center side of the first base member 55-1 and one inner surface 551b adjacent to the inner surface 551a. The first base member 55-1 also has a circular opening 553 penetrating in the thickness direction. As shown in the assembled yoke member 5 of FIGS. 2 and 4, the opening 553 is arranged on an axis P passing through the gap G (magnetic gap) between the first end portions 532a in pair and between the second end portions 542a in pair.

The second base member 55-2 has substantially the same thickness as the first base member 55-1. The second base member 55-2 has a circular opening 554 penetrating in the thickness direction. The opening 554 is arranged on the axis P passing through the gap G, as shown in the assembled yoke member 5 in FIGS. 2 and 4. Thus, the opening 554 and the opening 553 are coaxially arranged. Further, the inner diameter of the opening 554 is substantially the same as that of the opening 553.

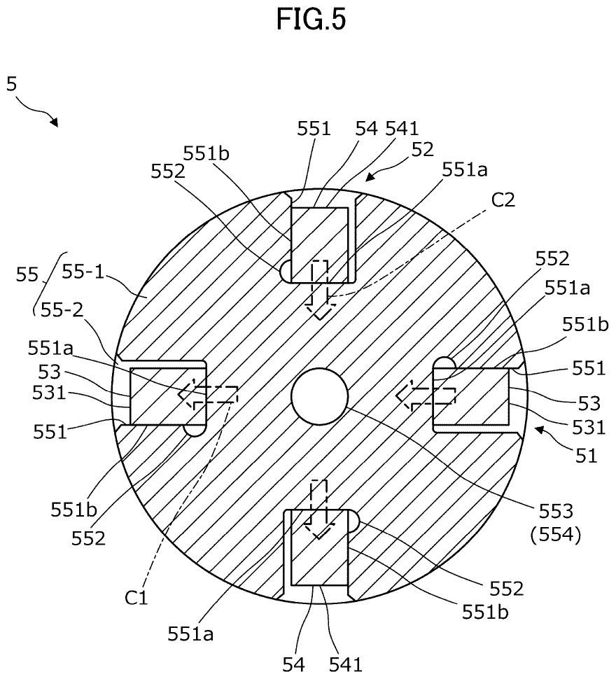

FIG. 5 is a cross-sectional view taken along line V-V, which shows the first base member 55-1 and the second base member 55-2 of the yoke member 5 shown in FIG. 2. As illustrated in FIG. 5, the first arm member 53 and the second arm member 54 are accommodated in the cut-out portions 551 and connected to the first base member 55-1. The first arm member 53 is accommodated so that it is in surface contact with the inner surface 551a of the cut-out portion 551 facing the center of the first base member 55-1 and its end portion 531a is in substantial surface contact with the upper surface of the second base member 55-2 (see also FIG. 4). Similarly, the second arm member 54 is accommodated so that it is in surface contact with the inner surface 551a of the cut-out portion 551 facing the center of the first base member 55-1 and its end portion 541a is in substantial surface contact with the upper surface of the second base member 55-2 (see also FIG. 4). Therefore, the second base member 55-2 is arranged on top of the first base member 55-1 so as to cover the end portions 531a, 541a of the first arm member 53 and the second arm member 54, each accommodated in the cut-out portion 551.

S Note that the width of the cut-out portion 551 (the inner width in the circumferential direction around the axis P) is wider than the first arm member 53 and the second arm member 54, and has a play sufficient to avoid pinching the arms (see FIG, 5), The first arm member 53 and the second arm member 54 are fixed to the first base member 55-1 within the cut-out portions 551 while being in contact with the inner surfaces 551b on the sides of the relief portions 552.

In the assembled state shown in FIG. 2 (see also FIG. 4), the first end portions 532a, 532a of the first yokes 51 in pair are arranged to face each other. The second end portions 542a, 542a of the second yokes 52 in pair face each other in a direction different from the direction in which the first end portions 532a, 532a face each other (in the present embodiment, a direction orthogonal to the direction in which the first end portions 532a, 532a face each other, in top view).

The support member 6 is arranged between the first end portions 532a of the first arm members 53 and provides support while maintaining a stable gap length of a gap G provided between the first end portions 532a. The support member 6 has a circular opening 61 that penetrates in the thickness direction (up-down direction) coaxially with the axis P. As illustrated in FIG. 4, the inner diameter of the opening 61 increases toward the inner side (lower side) of the yoke member S.

Ax illustrated in the exploded perspective view of FIG. 3, the support member 6 is formed to be substantially rotationally symmetric about the axis P (about the opening 61). The support member 6 has recesses 62 each in a substantially rectangular shape on its outer circumferential portion. The recesses 62 are provided at four positions rotated by 90 degrees around the axis P. A. bottom surface 621 of each recess 62 on the opening 61 side is formed in a planar shape. The recesses 62 accommodate protrusions 532 of the first arm members 53 and the protrusions 542 of the second arm members 54. The first end portions 532a of the first arm members 53 and the second end portions 542a of the second arm members 54 are in surface contact with the bottom surfaces 621 in the recesses 62. The support member 6 also has a flange 631 protruding outward in the radial direction with respect to the axis P of the opening 61, at an upper portion of the outer circumferential surface 63.

The deflection member 7 is arranged between the first end portions 532a in pair and between second end portions 542a in pair. The deflection member 7 includes a permanent magnet 71 and a reflection plate 72. The permanent magnet 71 has a substantially annular (doughnut) shape. The permanent magnet 71 has a circular opening 711 at its center portion, which penetrates in the thickness direction. Further, the permanent magnet 71 has one of the S or N poles at one end in the thickness direction (axial direction of the opening 711) and the other of the S or N poles at the other end.

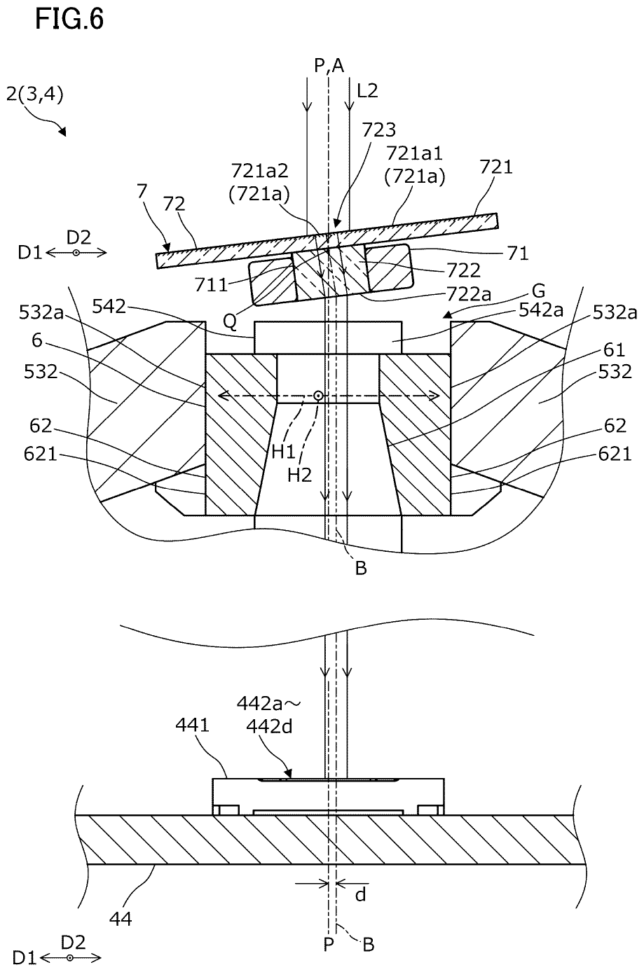

As illustrated in FIG. 6, the reflection plate 72 has a circular plate-like main body 721 and a supported part 722 that protrudes from the back surface side of the main body 721. The main body 721 and the supported part 722 are members made of a translucent material such as glass or plastic. The main body 721 has a reflection surface 721a that selectively reflects laser light L1 and laser light L2. The reflection surface 721a has a light selection unit 721a1 (second light selection unit) that reflects laser light L1 and laser light L2, and a light selection unit 721a2 (first light selection unit) that reflects laser light L1 and transmits laser light L2. The light selection unit 721a2 functions as an opening (aperture) having a predetermined shape that allows laser light L2 to pass through. The light selection unit 721a1 of the reflection plate is, for example, a metal reflective film or a dichroic filter formed by vapor deposition or the like. The light selection unit 721a2 is, for example, a dichroic filter. In the present embodiment, the laser light L2 is inclination detection light that enters from the reflection surface 721a side. As illustrated in FIG. 1, the laser light L2 is emitted from the light source 41, and after being focused by the lens 42, enters the deflection member 43 (the second deflection member). The deflection member 43 reflects the laser light L2 emitted from the light source 41 to the deflection member 7, and directs the laser light L2 onto the reflection surface 721a including the light selection unit 721a2.

The laser light L1 is distance measuring light that is guided to enter and be reflected at an angle different from that of the laser light L2 incident on a later-described light guide unit 723. For example, by setting the laser light L2 used as inclination detection light to have a wavelength different from that of the laser light L1 and using a dichroic filter as the light selection unit 721a2, the reflection surface 721a can have a region that reflects laser light L1 and transmits laser light L2.

The region of the light selection unit 721a2 in the reflection surface 721a is a circular region having a smaller diameter than the beam cross-sectional diameter of the laser light L2 incident on the deflection member 7. Therefore, the light selection unit 721a2 narrows the diameter of the laser light L2 while letting it pass. The laser light L2 entering through the light selection unit 721a2 passes through the main body 721 and the supported part 722, and is then emitted from the surface opposite to the reflection surface 721a. Therefore, the deflection member 7 has the light guide unit 723 that guides the laser light L2 from one side to another between the side of the reflection surface 721a and the surface opposite to the reflection surface 721a, In the present embodiment, the surface opposite to the reflection an emitting surface 722a of the laser light L2.

The supported part 722 has a short columnar shape. The supported part 722 engages with or fits into the opening 711 provided in the permanent magnet 71 and constitutes a part of the deflection member 7 that is integrated with the permanent magnet 71. The deflection member 7 has a rotation center point Q on the reflection surface 721a side. The rotation center point Q is a virtual point. The deflection member 7 is supported to be biaxially rotatable by a support part (not shown) so as to be rotatable about this rotation center point Q. For example. the deflection member 7 can rotate about the first direction DI or the second direction D2 with respect to the rotation center point Q. Note that the deflection member 7 may be supported by a multi-axis support part that allows rotation about three or more axes with respect to the rotation center point Q.

The light guide unit 723 of the present embodiment is an optical member arranged at the rotation center point Q of the reflection surface 721a. The incident surface (the region of the light selection unit 721a2 in the reflection surface 721a) and the emitting surface 722a for the laser light L2 in the light guide unit 723 are parallel to each other. Most of the light guide unit 723 is provided on the side far from the rotation center point Q. As illustrated in FIG. 6, the light guide unit 723 has a function of displacing the optical axis position of the laser light L2 from an optical axis A to an optical axis B by a displacement amount d, according to the inclination of the deflection member 7.

The scanner device drive circuit 14 illustrated in FIG. 1 includes yoke coils 533, 543 as load circuits, a drive circuit (or switching circuit) (not shown), and the like. The controller 11 controls the scanner device drive circuit 14 to supply excitation current to the yoke coil 533 and the yoke coil 543. This generates a magnetic field in the first magnetic path C1 of the first yoke 51 and the second magnetic path C2 of the second yoke 52 (see FIGS. 4 and 5), so that the magnetic field H1 in the first direction D1 between the first end portions 532a of the first yoke 51 and the magnetic field H2 in the second direction D2 between the second end portions 542a of the second yoke 52 are generated at an intensity designated by the controller 11 (see FIG. 6). The permanent magnet 71 receives attraction or repulsion from the magnetic field H1 and the magnetic field H2 generated in the first direction D1 and the second direction D2. According to the intensity of the magnetic fields H1 and H2, the deflection member 7 is angled about the rotation center point Q so as to have a predetermined inclination angle. The magnetic path length of the magnetic path including the pair of first arm members 53, 53 and the gap G in the first magnetic path C1, and the magnetic path length of the magnetic path including the pair of second arm members 54, 54 and the gap G in the second magnetic path C2 are set to be equal.

The first magnetic path C1 and the second magnetic path C2 illustrated in FIG. 5 bypass the opening 553 (554) and intersect around the opening 553 (554). Therefore, the first magnetic path C1 and the second magnetic path C2 have substantially the same magnetic path length within the base member 55. As described above, the first yokes 51 and the second yokes 52 share the base member 55 as a common component, and are connected to each other such that portions of the magnetic circuits intersect, thereby equalizing the magnetic path lengths of the closed circuits.

The detection circuit board 44 includes a detection unit 441 that is a light receiving element. The detection unit 441 is arranged on the side of the deflection member 7 opposite to the reflection surface 72 la (see FIG. 4 and the like). The detection unit 441 detects the laser light L2, which is the inclination detection light (second light) guided by the light guide unit 723.

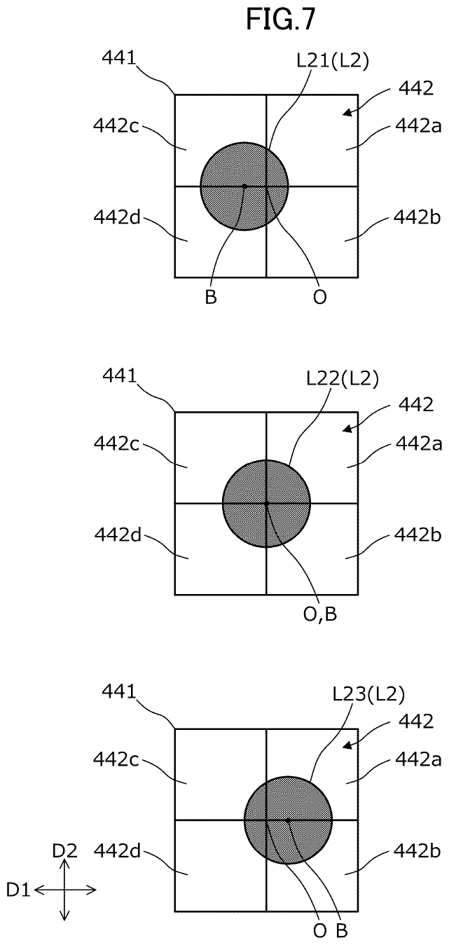

FIG. 7 is a schematic top view of the detection unit 441 of the present embodiment. The detection unit 441 is a quadrant photodetector (QPD) or a quadrant photodiode (QPD), and includes four light receiving unit 442a to 442d. The center point O of the light receiving units 442a to 442d is arranged at the axis P of the scanner device 2. The controller 11 can detect the inclination (inclination direction and inclination angle) of the deflection member 7 based on the position of the optical axis B (or the centroid) of the laser light L2 detected by the detection unit 441, or based on the distribution position of the laser light L2. More specifically, the controller 11 has a function of detecting the inclination of the deflection member 7 based on the intensity of the laser light L2 received by each of the light receiving units 442a to 442d of the quadrant light detection element.

For example, when the optical axis A of the laser light L2 coincides with the axis P. and the deflection member 7 is not inclined with respect to the optical axis A, the detection unit 441 is irradiated with the laser light L22 whose optical axis B substantially coincides with the center point O. Further, when the deflection member 7 is inclined leftward in FIG. 6 in the first direction D1, the laser light L2 is refracted in the light guide unit 723 and is emitted from the light guide unit 723 as the laser light L23 having the optical axis B that has shifted rightward in FIG. 6 with respect to the optical axis A at the time of incidence. Since the optical axis A and the optical axis B are parallel, the detection unit 441 illustrated in FIG. 7 is irradiated with the laser light L23 whose optical axis B is located to the right of the center point O. On the contrary, when the deflection member 7 is inclined rightward in FIG. 6 in the first direction D1, the laser light L2 is refracted in the light guide unit 723 and is emitted from the light guide unit 723 as the laser light L21 having the optical axis B that has shifted leftward in FIG. 6 with respect to the optical axis A at the time of incidence. In this case, the detection unit 441 illustrated in FIG. 7 is irrigated with the laser light L21 whose optical axis B is located to the left of the center point O.

The controller 11 determines the inclination (inclination direction and inclination angle) of the deflection member 7 based on the ratio of the intensity of the laser light L2 received by the light receiving units 442a to 442d. The controller 11 can determine the inclination of the deflection member 7 by calculating the position of the optical axis B (or the centroid of the received light intensity) with respect to the center point O of the laser light L2 incident on the light receiving unit 442 (in the first direction DI and the second direction D2). The distance of the optical axis B to the center point O corresponds to the inclination angle of the deflection member 7. Further, the displacement components of the optical axis B in the first direction D1 and the second direction D2 with respect to the center point O correspond to the inclination direction of the deflection member 7. The controller 11 may determine the correspondence between the position of the optical axis B with respect to the center point O and the inclination of the deflection member 7 by calculation, or may determine the same by referring to a pre-stored correspondence table.

The movable range of the laser light L2 is desirably at most 50% or less of the irradiation diameter (radius) of the laser light L2. That is, even when the deflection member 7 is inclined at the maximum inclination angle, the movable range of the optical axis B of the laser light L2 is set to be at most 50% or less of the irradiation diameter (radius) of the laser light L2. This makes it possible to ensure the linearity of the detection signal in response to a change in the angle of the deflection member 7, 7A. Further, even when the system is affected by external disturbances such as changes over time or vibrations, it is possible to keep the irradiation region of the laser light L2 from falling outside the detectable range, for example, by crossing the boundary lines of the light receiving units 442a to 442d.

FIG. 7 illustrates a state in which the laser light L2 passing through the light guide unit 723 having moved in the first direction D1. Similarly, when the laser light L2 moves in the second direction D2, it is possible to detect the inclination of the deflection member 7 with respect to the second direction D2.

In the inclination detection device 4 of the present embodiment, since the optical axis A and the optical axis B are parallel, the positional shift of the laser light L2 does not depend on the distance from the emitting surface 722a of the light guide unit 723 to the detection unit 441. Therefore, it is sufficient to arrange the detection unit 441 such that the center point O of the light receiving units 442a to 442d lies on the axis P. Therefore, the scanner device 2 has a high degree of freedom in the arrangement of the detection unit 441.

The optical axis A and the center point O do not necessarily have to coincide with each other. By determining, in advance, a reference position as the position (centroid position) of the optical axis B of the laser light L2 detected by the detection unit 441 when the deflection member 7 is not inclined, it is possible to correct, in advance, the relationship between the position of the optical axis B of the laser light L2 detected by the detection unit 441 and the inclination of the deflection member 7.

### Second Embodiment

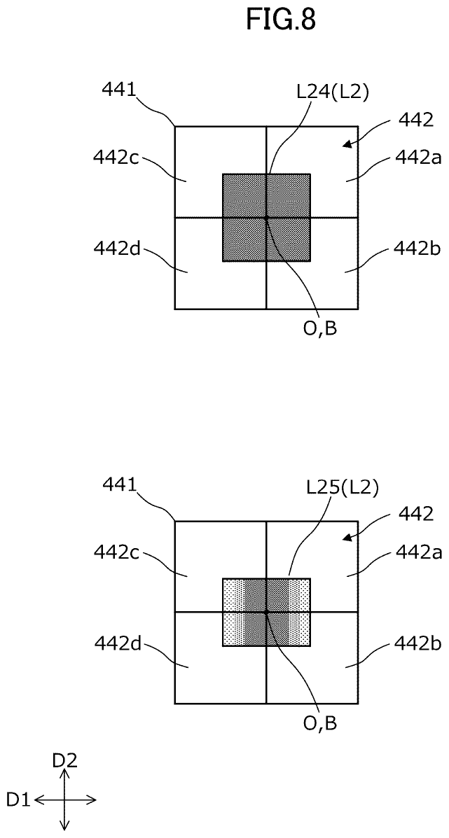

Next, the second embodiment will be described. In the secon embodiment, the light selection unit 721a2 is formed as a rectangular region instead of a circular region. Therefore, the laser light L2 that has passed through the light selection unit 721a2 has a rectangular beam cross-sectional shape. FIG. 8 shows an irradiation region of the laser light L24 that is emitted toward the light receiving unit 442 via the light selection unit 721a2, which is formed in a substantially square shape.

In this way, when the optical axis B (or the centroid) of the rectangular laser light L24 moves in the first direction D1 or the second direction D2, the use of the rectangular laser light L24 helps suppress a significant decrease in light intensity at the light receiving units 442a to 442d on the side opposite to the direction of movement of the optical axis B. Therefore, it is possible to enhance the linearity of the relationship between the displacement amount of the optical axis B and the change in the light intensity detected by the light receiving units 442a to 442d. Therefore, the amount of inclination of the deflection member 7 can be determined more accurately.

### Third Embodiment

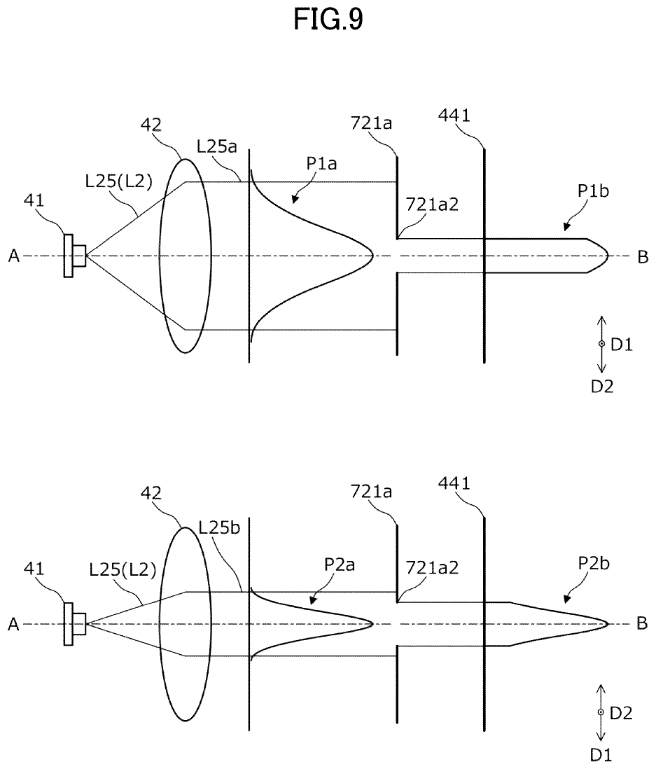

Next, the light selection unit 721a2 of the third embodiment will be described. The light selection unit 721a2 of the deflection member 7 is formed in an elongated rectangular shape in a top view of the reflection surface 721a. FIG. 9 is a schematic view showing changes in the intensity distribution of the laser light L25 in the optical path from the light source 41 to the detection unit 441, as viewed from two orthogonal directions. The laser light L25 emitted from the light source 41 has different spread angles in two directions orthogonal to each other That is, the laser light L25 has a substantially elliptical beam cross-sectional shape. The example of FIG. 9 shows changes in the intensity distributions P1a and P1b when a major-axis direction of the laser light L25 is viewed from a side in the first direction D1, and changes in the intensity distributions P2a and P2b when a minor-axis direction of the laser light L25 is viewed from a side in the second direction D2.

A component L25b in the minor-axis direction of the laser light L25 has a distribution more concentrated on the optical axis A side than a component L25a in the major-axis direction. The light selection unit 721a2 of the third embodiment has an elongated rectangular region whose opening width for the component L25b in the minor-axis direction is wider than that for the component L25a in the minor-axis direction. FIG. 8 shows an irradiation region of the laser light L25 that is emitted toward the light receiving unit 442 via the light selection unit 721a2 of S the third embodiment. The shading in the irradiation region of the laser light L25 represents the strength of the received light intensity. Thus, by narrowing the opening width in the direction in which the intensity of the laser light L25 is relatively uniform, and widening the opening width in the direction in which the intensity of the laser light L25 is biased toward the optical axis A, B, it is possible to adjust the total received light intensities in the first direction DI and the second direction D2 to be equal or approximately equal. As a result, when the optical axis B of the laser light L25 detected by the detection unit 441 shifts, the difference in sensitivity between the first direction D1 and the second direction D2 can be reduced.

When the opening shape of the light selection unit 721a2 is an elongated rectangular shape, it is desirable to set the orientation of the light selection unit 721a2 so that the major-axis direction of the opening shape aligns with the direction in which the laser light L25 has weak intensity.

### Fourth Embodiment

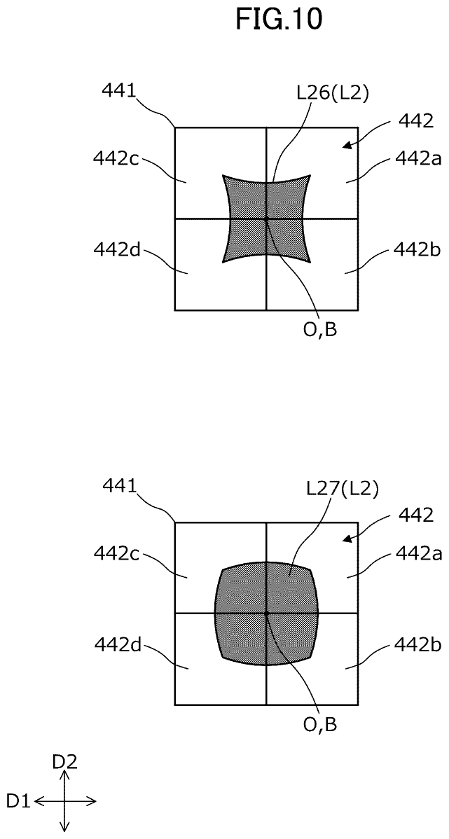

Next, the fourth embodiment will be described. In the fourth embodiment, the light selection unit 721a2 of the deflection member 7 is formed in a substantially rectangular shape having sides that are concavely curved toward the axis P in a top view of the reflection surface 721a. FIG. 10 shows an irradiation region of the laser light L26 that is emitted toward the light receiving unit 442 via the light selection unit 721a2, which is formed in a substantially rectangular shape with sides that are concavely curved. As described above, the laser light L2 that has passed through the light selection unit 721a2 has a beam cross-sectional shape that is substantially rectangular, with each side concavely curved toward the optical axis A and B.

### Fifth Embodiment

Next, the fifth embodiment will be described. In the fifth embodiment, the light selection unit 721a2 of the deflection member 7 is formed in a substantially rectangular shape having sides that are convexly curved radially outward with respect to the axis P, in a top view of the reflection surface 721a. FIG. 10 shows the irradiation region of the laser light L27 that is emitted toward the light receiving unit 442 via the light selection unit 721a2, which is formed in a substantially rectangular shape with sides that are convexly curved. As described above, the laser light L2 that has passed through the light selection unit 721a2 has a beam cross-sectional shape that is substantially rectangular, with each side convexly curved outward toward the optical axis A and B.

In the present embodiment, an inclination detection method for an inclination detection device 4 has been described, wherein the inclination detection device 4 includes an angle-controllable deflection member 7 having a reflection surface 721a that reflects laser light L1 (first light) and a light guide unit 723 that guides laser light L2 (second light) from one side to another between the side of the reflection surface 721a and the side opposite to the reflection surface 721a, and a detection unit 441 configured to detect the laser light L2 (second light) guided by the light guide unit 723. In this inclination detection method, the light guide unit 723 displaces the optical axis A of the laser light L2 (second light) according to the inclination of the deflection member 7, and the controller 11 detects the inclination of the deflection member 7 based on the position of the optical axis B of the laser light L2 (second light) detected by the detection unit 441.

With such a configuration, the inclination detection device 4 and the inclination detection method can detect the inclination state of the controlled member (the deflection member 7 or a later-described deflection member 7A) in a simple manner and with high accuracy,

### Sixth Embodiment

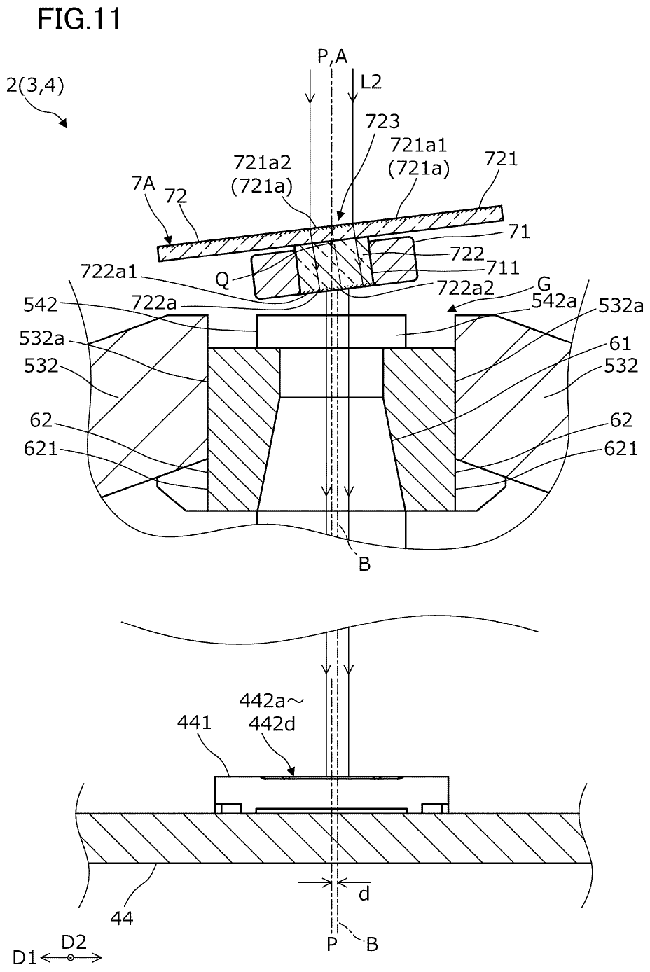

Next, a scanner device 2 of the sixth embodiment will be described FIG. 11 is an enlarged cross-sectional view of a portion of the configuration of the scanner device 2 according to the sixth embodiment, which corresponds to the cross-section taken along line IV-IV of Embodiment 1. The light source device 1 of the sixth embodiment includes a deflection member 7A instead of the deflection member 7. Note that descriptions of configurations of the deflection member 7A that are similar to those of the deflection member 7 are omitted or simplified.

The deflection member 7A has, on the reflection surface 721a, a light selection unit 712a2 having a larger opening diameter (or opening width) than that of the light selection unit IS 712a2 in the first embodiment. The light selection unit 712a2 provided on the reflection surface 721a of the deflection member 7A transmits the laser light L2 guided as detection light, and guides it into the main body portion 721 on the emitting surface 722a side and into the supported part 722.

Further, the deflection member 7A bas, on its emitting surface 722a, a light selection unit 722a1 (second light selection unit) and a light selection unit 722a2 (first light selection unit). The light selection unit 722a1 reflects or absorbs the laser light L2. Further, the light selection unit 722a2 transmits the laser light L2. The light selection unit 722a1 is, for example, a metal reflective film or a dichroic filter. The light selection unit 722a2 is, for example, a dichroic filter, or a region where the supported part 722 is exposed (Le., a region where nothing is provided).

The region of the light selection unit 722a2 in the emitting surface 722a is a circular region having a smaller diameter than the beam cross-sectional diameter of the laser light L2 that has passed through the reflection surface 721 a of the deflection member 7A. Therefore, the light selection unit 722a2 narrows the diameter of the laser light L2 while letting it pass. The laser light L2 entering from the supported part 722 side into the region of the light selection unit 722a2 is emitted from the emitting surface 722a toward the detection unit 441 side.

When the deflection member 7A is used in the inclination detection device 4, the light selection unit 722a2, which narrows the laser light L2, is provided closer to the detection unit 441. As a result, even if the deviation between the optical axis B and the axis P is large, or if the laser light L2 transmitted through the light guide unit 723 contains a diffused component, it is possible to reduce the detection error in the position of the optical axis B and to determine the inclination of the deflection member 7A more accurately.

### Seventh Embodiment

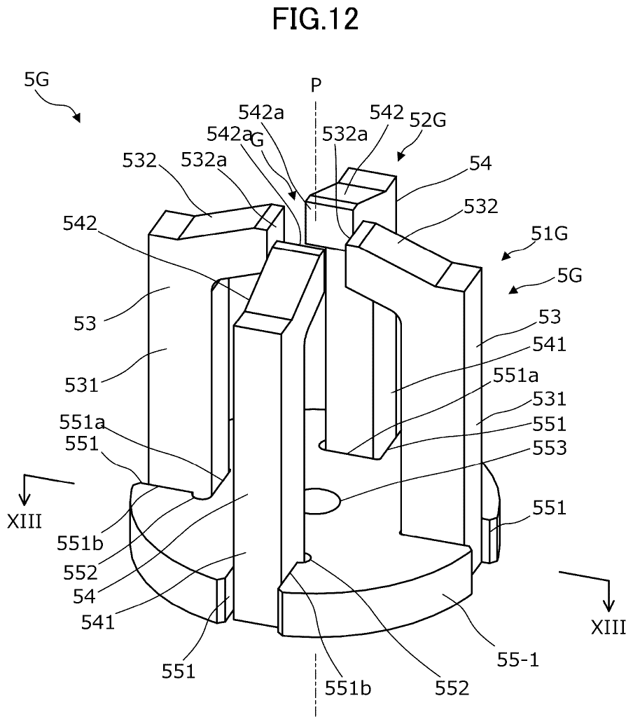

Next, the light source device 1 of the seventh embodiment will be described. FIG. 12 is a perspective view of a yoke member 5G of the seventh embodiment. In the configuration of the scanner device 2, the light source device 1 includes a yoke member 5G instead of the yoke member 5 described in the first embodiment. In the description of the seventh embodiment, the same reference characters as those of the light source device 1 according to the first embodiment are given to represent equivalent configurations, and the detailed description thereof will be omitted or simplified.

The yoke member 5G has a configuration in which the second base member 55-2 is omitted from the configuration of the yoke member 5. Specifically, the yoke member 5G includes a pair of first yokes 51G and a pair of second yokes 52G arranged in a rotationally symmetrical position about the axis P, which is different from the first yokes 51G. The first yokes 51G include a pair of first arm members 53, 53 and a base member 55G, The second yokes 52G include a pair of second arm members 54, 54 and the base member 55G. The base member 55G includes the first base member 55-1 described above. The first arm members 53 and the second arm members 54 are connected to the first base member 55-1 in the similar manner as the yoke member 5 of the first embodiment.

The first magnetic path C1 in the yoke member 5G forms a closed path by a gap G provided between the first arm members 53 in pair, the base member 55G (first base member 55-1), and the first end portions 532a of the first arm members 53. Further, the second magnetic path C2 forms a closed path by a gap O provided between the second arm members 54 in pair, the base member 55G (first base member 55-1), and the second end portions 542a of the second arm members 54.

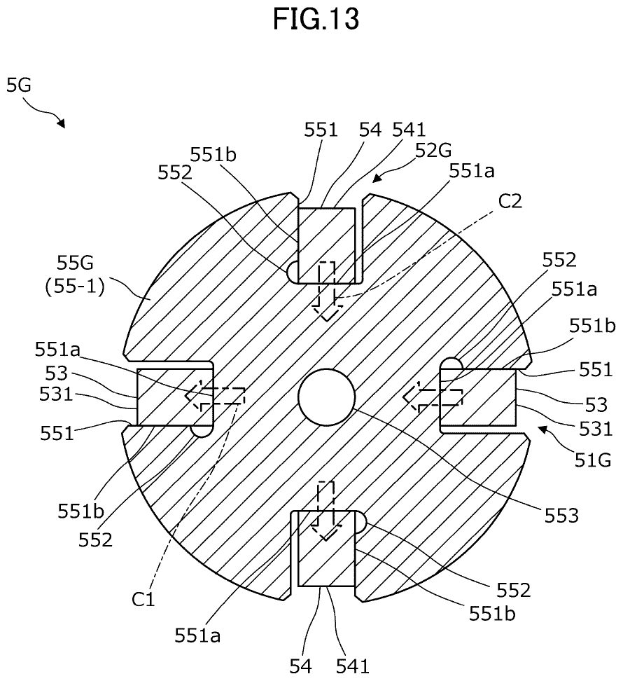

FIG. 13 is a cross-sectional view of the yoke member 5G taken along line XIII-XIII in FIG. 12. Similarly to the V-V cross-section of the base member 55 in the first embodiment (see FIG. 5), the first magnetic path C1 and the second magnetic path C2 bypass the opening 553 and intersect around the opening 553. Therefore, the first magnetic path C1 and the second magnetic path C2 have substantially the same magnetic path length within the base member 55. Further, the magnetic path length of the magnetic path including the pair of first arm members 53, 53 and the gap G in the first magnetic path C1, and the magnetic path length of the magnetic path including the pair of second arm members 54, 54 and the gap G in the second magnetic path C2 are equal to each other. Therefore, the first yokes 51G and the second yokes 52G are connected to each other such that portions of the magnetic circuits intersect, thereby equalizing the magnetic path lengths of the closed circuits.

This configuration of the yoke member 5G allows the overall size of the yoke member 5G to be reduced.

### Eighth Embodiment

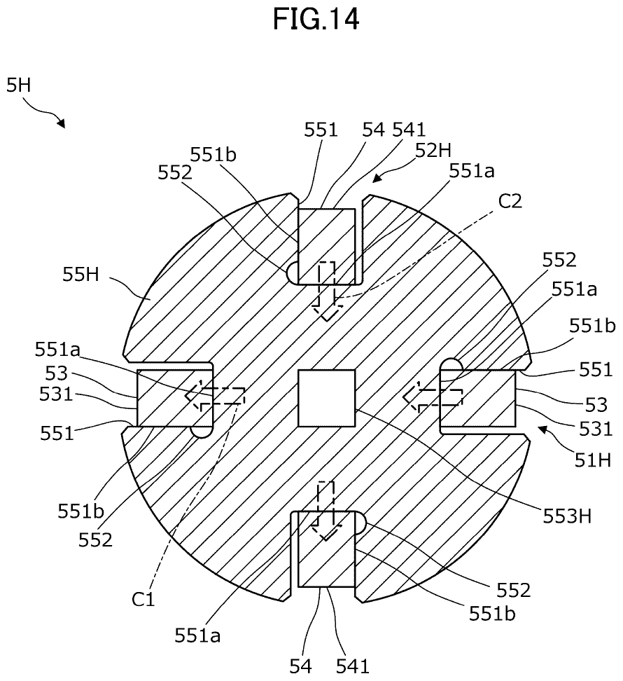

Next, the light source device 1 of the eighth embodiment will be described. FIG. 14 is a cross-sectional view of the base member SSH, the first arm members 53, and the second arm members 54 of a yoke member 5H in the eighth embodiment, taken at a position corresponding to the XIII-XIII cross section of the yoke member 5G shown in FIG. 12. In the description of the eighth embodiment, the same reference characters as those of the light source device 1 according to the seventh embodiment are given to represent equivalent configurations, and the detailed description thereof will be omitted or simplified.

In the configuration of the scanner device 2, the light source device 1 of the eighth embodiment includes the yoke member SH instead of the yoke member 5G described in the seventh embodiment. That is, the yoke member 5H has a base member 55H instead of the base member 55G. This base member 55H has a configuration similar to that of the first base member 55-1, but includes a rectangular opening 553H, such as a square opening, instead of the circular opening 553. The opening 553H extends through the base member 55H in the thickness direction.

The yoke member SH has a rectangular opening 553H, which makes it possible to ensure a wide irradiation region of the laser light L2 directed toward the rectangular light receiving unit 442, Further, when the laser lights L24 to L27 having a shape close to a rectangle as shown in FIG. 8 and FIG. 10 are directed, the detection range of the light receiving unit 442 can be widely used. Therefore, the detection sensitivity of the light receiving unit 442 can be increased by enlarging the movable range of the optical axis B of the laser light L2 relative to the inclination angle of the deflection member 7.

### Ninth Embodiment

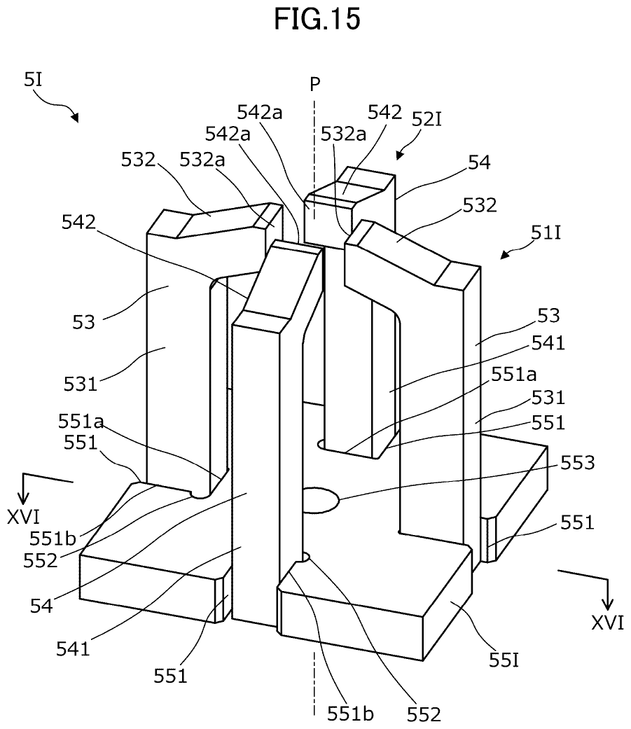

Next, the light source device 1 of the ninth embodiment will be described. FIG. 15 is a perspective view of a yoke member 5I of the ninth embodiment. In the configuration of the scanner device 2, the light source device 1 includes a yoke member 5I instead of the yoke member 5 described in the first embodiment. In the description of the ninth embodiment, the same reference characters as those of the light source device 1 according to the first embodiment are given to represent equivalent configurations, and the detailed description thereof will be omitted or simplified.

The yoke member 5I has a quadrangular plate-like base member 55I instead of the base member 55 in the configuration of the yoke member 5. The base member 55I is configured as a base member corresponding to the first base member 55-1 of the base member 55. Specifically, the yoke member 5I includes a pair of first yokes 51I and a pair of second yokes 521 arranged in a rotationally symmetrical position about the axis P, which is different from the first yokes 51I. The first yokes 51I include a pair of first arm members 53, 53 and a base member 55I. The second yokes 52I include a pair of second arm members 54, 54 and the base member 55I. The first arm members 53 and the second arm members 54 are connected to cut-out portions 551 of the base member 55I in the similar manner as the yoke member 5 of the first embodiment.

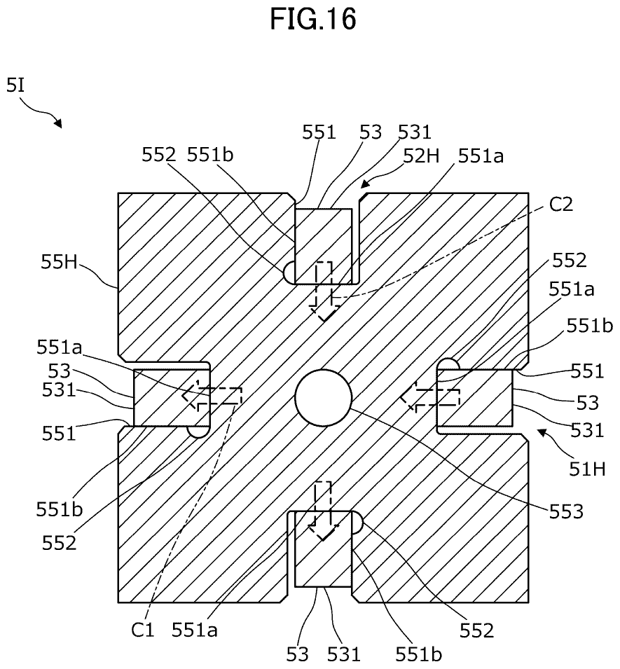

The first magnetic path C1 in the yoke member 5I forms a closed path by a gap O provided between the first arm members 53 in pair, the base member 55I, and the first end portions 532a of the first arm members 53. Further, the second magnetic path C2 forms a closed path by a gap G provided between the second arm members 54 in pair, the base member 55I, and the second end portions 542a of the second arm members 54. Further, FIG. 16 is a cross-sectional view of the yoke member 5I taken along line XVI-XVI in FIG. 15. Similarly to the V-V cross-section of the base member 55 in the first embodiment (see FIG. 5), the first magnetic path C1 and the second magnetic path C2 bypass the opening 553 and intersect around the opening 553. Therefore, the first magnetic path C1 and the second magnetic path C2 have substantially the same magnetic path length within the base member 55, Further, the magnetic path length of the magnetic path including the pair of first arm members 53, 53 and the gap G in the first magnetic path C1, and the magnetic path length of the magnetic path including the pair of second arm members 54, 54 and the gap G in. the second magnetic path C2 are equal to each other. Therefore, the first yokes 51I and the second yokes 52I are connected to each other such that portions of the magnetic circuits intersect, thereby equalizing the magnetic path lengths of the closed circuits.

### Tenth Embodiment

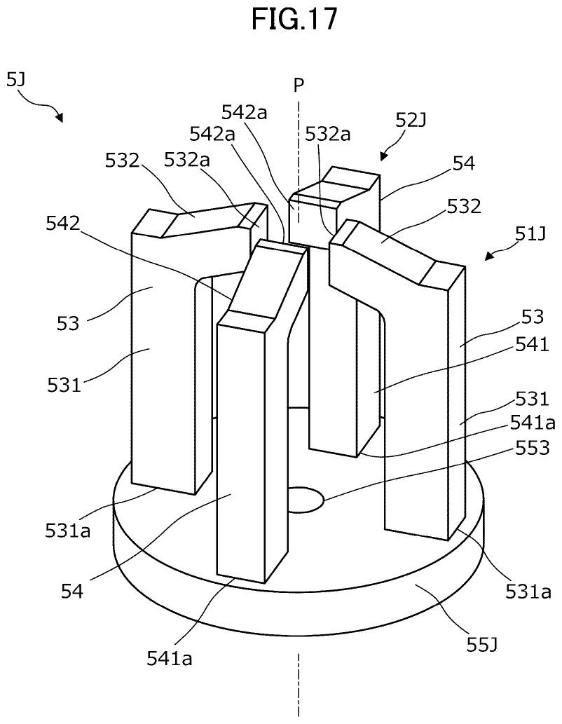

Next, the light source device 1 of the tenth embodiment will be described. FIG. 17 is a perspective view of a yoke member 5J of the tenth embodiment. In the configuration of the scanner device 2, the light source device 1 includes a yoke member 5J instead of the yoke member 5 described in the first embodiment. In the description of the tenth embodiment, the same reference characters as those of the light source device 1 according to the first embodiment are given to represent equivalent configurations, and the detailed description thereof will be omitted or simplified.

The yoke member 5J includes a pair of first yokes 51J and a pair of second yokes 52J arranged in a rotationally symmetrical position about the axis P, which is different from the first yokes 51J. The first yokes 51J include a pair of first arm members 53, 53 and a base member 55J. The second yokes 52J include a pair of second arm members 54, 54 and the base member 553. The base member 55J has a disc-like shape as in the second base member 55-2 described above, The first arm member 53 and the second arm member 54 are fixed to one surface 55J1 of the base member 55J in a state where each of the end portions (first base end portions 531a of the first arm members 53 and second base end portions 541a of the second arm members 54) are in contact with the surface. The first arm members 53 and the second arm members 54 are fixed to the base member 55J by fixing members (not shown).

The first magnetic path C1 in the yoke member 5J forms a closed path by a gap G provided between the first arm members 53 in pain, the base member 55J, and the first end portions 532a of the first arm members 53. Further, the second magnetic path C2 forms a closed path by a gap G provided between second arm members 54 in pair, the base member 55J, and the second end portions 542a of the second arm members 54.

Similarly to the V-V cross-section of the base member 55 in the first embodiment (see FIG. 5), the first magnetic path C1 and the second magnetic path C2 of the base member 55J bypass the opening 553 and intersect around the opening 553 (not shown). Therefore, the first magnetic path C1 and the second magnetic path C2 have substantially the same magnetic path length within the base member 55. Further, the magnetic path length of the magnetic path including the pair of first arm members 53, 53 and the gap O in the first magnetic path C1, and the magnetic path length of the magnetic path including the pair of second arm members 54, 54 and the gap O in the second magnetic path C2 are equal to each other. Therefore, the first yokes 51J and the second yokes 521 are connected to each other such that portions of the magnetic circuits intersect, thereby equalizing the magnetic path lengths of the closed circuits.

This configuration of the yoke member 5J allows the overall size of the yoke member 5J to be reduced.

Thus, a configuration has been described above in which the light guide unit 723 displaces the optical axis B of the second light (laser light L2) according to the inclination of the deflection member 7, 7A, and the controller 11 detects the inclination of the deflection member 7, 7A based on the position of the optical axis of the second light detected by the detection unit 441. The movable range of the laser light L2 incident on the detection unit 441 is smaller than that when the laser light L2 is reflected by the deflection member 7, 7A and thus the detection unit 441 can be configured in a compact manner. Therefore, the inclination detection device 4 can detect the inclination state of the controlled member in a simple manner and with high accuracy.

Further, a yoke member 5, 5G to 5J has been describe above, which includes the first yokes 51, 51G, 51I, 51J having a pair of first end portions 532a facing each other, and the second yokes 52, 52G, 52I, 52J having a pair of second end portions 542a facing each other in a direction different from the facing direction of the first end portions 532a. In each of the yoke members 5, 5G to 5J, the first yokes 51, 51G, 51I, 51J and the second yokes 52, 52G, 52I, 52J are connected such that portions of the magnetic circuits intersect, thereby equalizing the magnetic path lengths. Therefore, since the members constituting the first magnetic path CI and the second magnetic path C2 are made common, the yoke members 5, 5G to 5J and the scanner device 2 can be downsized.

The embodiments of the present disclosure have been described above, but the aspects of the present disclosure are not limited to the embodiments.

For example, the detection unit 441 may be a two-segment photodetector if the direction of rotation of the deflection member 7, 7A is in a single direction. The detection unit 441 may be an image sensor.

The light selection unit 721a2 may be configured to transmit both the laser light L1 and the laser light L2.

Further, the laser light L2 may be directed to the reflection surface 721a of the deflection member 7, 7A as distance measuring light, together with the laser light L1. In this case, the optical axis A of the laser light L2 and the axis P of the scanner device 2 do not have to coincide with each other. If the light guide unit 723 is configured such that the refraction angle of the laser light L2 entering from the reflection surface 721a changes according to the inclination of the deflection member 7, 7A, the optical axis B of the laser light L2 emitted from the light guide unit 723 changes according to the inclination of the deflection member 7, 7A. Therefore, the inclination state of the deflection member 7, 7A (controlled member) can be detected in a simple manner and with high accuracy, even when the laser light L2 is guided as part of the distance measuring light together with the laser light L1.

The positional relationship between the light source 41 and the detection unit 441 shown in FIG. 1 may be reversed. In other words, the laser light L2 may enter from the surface indicated as the emitting surface 722a of the deflection member 7, 7A (see FIG. 6 and the like). and be guided along an optical path to exit from the reflection surface 721a.

Further, the detection unit 441 may be provided between the deflection member 7 and the base member 55. This makes it possible to downsize the entire scanner device 2

The distance measuring light optical system 12 of the present disclosure may also be used to guide light for purposes other than distance measurement.

An exemplary configuration of the present disclosure is as follows
[1] A yoke member including:
first yokes having a pair of first end portions facing each other; and
second yokes having a pair of second end portions facing each other in a direction different from a facing direction of the first end portions, wherein
the first yokes and the second yokes are connected such that portions of magnetic circuits intersect, thereby equalizing magnetic path lengths.
[2] The yoke member of [1], wherein
the first yokes include a pair of first arm members having the first end portions, and a base member connected to a side opposite to the first end portions of the first arm members, and
the second yokes include a pair of second arm members having the second end portions, and the base member connected to a side opposite to the second end portions of the second arm members.
[3] The yoke member of [2], wherein
the base member has cut-out portions on two sets of opposing side edges, and
the first arm members and the second arm members are accommodated in the cut-out portions and connected to the base member.
[4] The yoke member of [2], wherein
the base member has a plate-shaped first base member having cut-out portions on two sets of opposing side edges, and a plate-shaped second base member,
the first arm members and the second arm members are accommodated in the cut-out portions and connected to the first base member, and
the second base member is arranged on top of the first base member so as to cover the end portions of the first arm members and the second arm members accommodated in the cut-out portions.
[5] The yoke member of [4], wherein
the first arm members and the second arm members are accommodated in the cut-out portions, in contact with an inner surface on a center side of the first base member and with end portions in contact with the second base member.
[6] The yoke member of [2], wherein
the base member has a through-opening on an axis passing through a magnetic gap between the first end portions in pair and between the second end portions in pair.
[7] The yoke member of [2], wherein
the base member is formed in a quadrangular shape.
[8] The yoke member of claim [2], wherein
the base member is formed in a disc shape.
[9] A scanner device, including:
an electromagnet having the yoke member of [1], and yoke coils provided on the first arm members of the first yokes and the second arm members of the second yokes, and
a reflection member that is arranged between the first end portions in pair and between the second end portions in pair and is angle-controlled by the electromagnet.

### DESCRIPTION OF REFERENCE CHARACTERS

1 Light Source Device
2 Scanner Device
3 Mirror Control Device
4 Inclination Detection Device
5, 5G to 5J Yoke Member
6 Support Member
7, 7A Deflection Member
11 Controller
12 Distance Measuring Light Optical System
13 Optical System Drive Circuit
14 Scanner Device Drive Circuit
15 Angle Sensor Circuit
41 Light Source
42 Lens
43 Deflection Member
44 Detection Circuit Board
51, 51G, 51I, 51J First Yoke
52, 52G, 52I, 52J Second Yoke
53 First Arm Member
54 Second Arm Member
55, 55G to 55J Base Member
55-1 First Base Member
55-2 Second Base Member
55J1 Surface
55a Side Edge
61 Opening
62 Recess
63 Outer Circumferential Surface
71 Permanent Magnet
72 Reflection Plate
441 Detection Unit
531 Body Part
531a First Base End Portion
532 Protrusion
532a First End Portion
533 Yoke Coil
553H Opening
541 Body Part
541a Second Base End Portion
542 Protrusion
542a Second End Portion
543 Yoke Coil
551 Cut-Out Portion
551a Inner Surface
551b Inner Surface
552 Relief Portion
553 Opening
554 Opening
621 Bottom Surface
631 Flange
711 Opening
712a2 Light Selection Unit
721 Main Body
721a Reflection Surface
721a1 Light Selection Unit
721a2 Light Selection Unit
722a Emitting Surface
722a1 Light Selection Unit
722a2 Light Selection Unit
723 Light Guide Unit
A, B Optical Axis
C1 First Magnetic Path
C2 Second Magnetic Path
D1 First Direction
D2 Second Direction
G Gap
L1 (L11, L12) Laser Light
L2 (L21 to L27, L25a, L25b) Laser Light
L3 Reflected Light
O Center Point
P Axis
Q Rotation Center Point

1. A yoke member comprising;
first yokes having a pair of first end portions facing each other; and
second yokes having a pair of second end portions facing each other in a direction different from a facing direction of the first end portions, wherein
the first yokes and the second yokes are connected such that portions of magnetic circuits intersect, thereby equalizing magnetic path lengths.

2. The yoke member of claim 1, wherein
the first yokes include a pair of first arm members having the first end portions, and a base member connected to a side opposite to the first end portions of the first arm members, and
the second yokes include a pair of second arm members having the second end portions, and the base member connected to a side opposite to the second end portions of the second arm members.

3. The yoke member of claim 2, wherein
the base member has cut-out portions on two sets of opposing side edges, and
the first arm members and the second arm members are accommodated in the cut-out portions and connected to the base member.

4. The yoke member of claim 2, wherein
the base member has a plate-shaped first base member having cut-out portions on two sets of opposing side edges, and a plate-shaped second base member.
the first arm members and the second arm members are accommodated in the cut-out portions and connected to the first base member, and
the second base member is arranged on top of the first base member so as to cover end portions of the first arm members and the second arm members accommodated in the cut-out portions.

5. The yoke member of claim 4, wherein
the first arm members and the second arm members are accommodated in the cut-out portions, in contact with an inner surface on a center side of the first base member and with the end portions in contact with the second base member.

6. The yoke member of claim 2, wherein
the base member has a through-opening on an axis passing through a magnetic gap between the first end portions in pair and between the second end portions in pair.

7. The yoke member of claim 2, wherein
the base member is formed in a quadrangular shape.

8. The yoke member of claim 2, wherein
the base member is formed in a disc shape,

9. A scanner device, comprising:
an electromagnet having the yoke member of claim 1, and yoke coils provided on the first arm members of the first yokes and the second arm members of the second yokes; and
a deflection member that is arranged between the first end portions in pair and between the second end portions in pair and is angle-controlled by the electromagnet.
